(19) United States
(12) Patent Application Publication
(10) Pub. No.: US 2024/0354240 A1
(43) Pub. Date: Oct. 24, 2024

(54) METHOD FOR GENERATING AT LEAST ONE NEW TEST CASE BASED ON A BLACK BOX FUZZING OF A TARGET PROGRAM TO BE TESTED

(71) Applicant: Robert Bosch GmbH, Stuttgart (DE)

(72) Inventor: Maria Irina Nicolae, Stuttgart (DE)

(21) Appl. No.: 18/582,282

(22) Filed: Feb. 20, 2024

(30) Foreign Application Priority Data
Apr. 20, 2023 (DE) 10 2023 203 621.5

(51) Int. Cl. G06F 11/36

(52) U.S. Cl. CPC G06F 11/3688; G06F 11/3684

(57) ABSTRACT

A method for generating at least one new test case based on black box fuzzing of a target program to be tested. The method includes: providing at least one specified test case; predicting at least one item of secondary information based on the provided specified test case, wherein the at least one secondary information is specific for an effect of the provided specified test case on the target program to be tested; generating the at least one new test case based on the prediction.

### CROSS REFERENCE

The present application claims the benefit under 35 U.S.C. § 119 of German Patent Application No. DE 10 2023 203 621.5 filed on Apr. 20, 2023, which is expressly incorporated herein by reference in its entirety.

### FIELD

The present invention relates to a method for generating at least one new test case based on a black box fuzzing of a target program to be tested. The present invention further relates to a training method, a model, a computer program, a device, and a storage medium for this purpose.

### BACKGROUND INFORMATION

From the related art, black box fuzzing is known as a method of software testing in which an application is treated as a black box and is presented with a large number of random and unpredictable inputs in order to identify bugs or security holes. In this method, the internal functioning of the application cannot typically be considered. Feedback on unexpected behavior may identify potential vulnerabilities to improve the security and stability of the application. A typical black box fuzzing setup may comprise a seed, a fuzzer, and a target program.

A black box fuzzer may conventionally generate inputs for a target program without knowing its internal behavior or implementation. In this case, the source code of the program is not available, which prevents the fuzzer from receiving feedback, e.g., code coverage or path coverage, which could guide the generation of additional test cases. The fuzzer tests essentially randomly, and has no way to improve over time. This is common, for example, when testing embedded devices and their software. Another application of black box fuzzing is for programs that do not have deterministic outputs relative to their inputs.

### SUMMARY

The present invention includes a method, a training method, a model, a computer program, a device, and a computer-readable storage medium. Further features and details of the present invention emerge from the disclosure herein. Features and details which are described in connection with the method according to the present invention will of course also apply in connection with the training method according to the present invention, the model according to the present invention, the computer program according to the present invention, the device according to the present invention, and the computer-readable storage medium according to the present invention, and vice versa, so that mutual reference is or can always be made with respect to the disclosure of the individual aspects of the present invention.

The present invention relates particularly to a method for generating at least one new test case for a fuzzing, preferably based on a black box fuzzing, of a target program to be tested. The target program may also be part of an embedded system, for example, for controlling an at least semi-autonomous robot, preferably a vehicle.

According to an example embodiment of the present invention, the method may comprise, according to a first method step, providing at least one specified test case, in particular for black box fuzzing. Such a test case may comprise, for example, one or more program inputs for the target program, which are used to test the target program. The target program for the fuzzing may be presented with a large number of said test cases and the corresponding program inputs, without feedback, such as code coverage or path coverage of the target program, being available.

The method according to the present invention may serve to ensure that, in contrast to conventional solutions, an effect of the program inputs on the target program can still be considered when fuzzing. In so doing, the black box fuzzing may be enhanced by machine learning to use the effect as a guiding criterion, in the manner of gray box fuzzing or white box fuzzing. According to a second method step of the method according to an example embodiment of the present invention, it may therefore be provided that at least one item of secondary information is predicted based on the provided specified test case. In so doing, the at least one item of secondary information may be specific to the effect of the specified test case provided on the target program to be tested. In other words, instead of capturing feedback, such as code coverage, which could actually be captured optionally at the target program during gray box fuzzing or white box fuzzing, the secondary information can be predicted. This allows fuzzing to consider the secondary information as a different form of feedback by a prediction, for example by a machine learning algorithm. The effect may be used in the same or a similar way in black box fuzzing as the feedback is otherwise used in gray box fuzzing or white box fuzzing. According to a third method step, for example, at least one new test case may then be generated based on the prediction. Thus, the present invention may allow black box fuzzing to be directed using machine learning of information accompanying the program, even if there is no access to the program source code.

The present invention relates in particular to the dynamic software testing method fuzzing, enhanced with items of secondary information that may be used as feedback mechanisms. Specifically, the fuzzing may be implemented as black box fuzzing, where the source code of the tested program, also hereinafter referred to as the target program, is not available. Fuzzing is explained in more detail in [4], for example, wherein the references set in brackets are listed at the end of the description. The target program may be monitored by means of fuzzing for exceptions such as crashes, failed integrated code assertions, or potential memory leaks. To do so, fuzzers that process structured inputs may be used to test target programs. This structure may be specified, for example, in a particular format or protocol, and may distinguish valid from invalid inputs. An effective fuzzer may therefore generate semi-valid inputs that are ‘valid enough’ not to be directly rejected by the target program, but that produce unexpected behaviors in the deeper regions of the target program and are ‘invalid enough’ to uncover corner cases that have not been handled properly. Thus, fuzz testing or fuzzing may include an automated process in which randomly generated inputs are sent to a target program and its response is observed. Accordingly, a fuzzer, also known as a fuzzing engine, is in particular software that automatically generates inputs. It is possible that the fuzzer is neither connected to the target program to be tested nor is instrumented. Conventional examples of fuzzers are afl and libfuzzer.

The software to be tested may also be referred to as a target program or fuzz target. In particular, a software program having a plurality of functions or even only one function that is to be tested by fuzzing is understood as a target program. A key feature of a fuzz target may be that it processes potentially untrustworthy inputs generated by the fuzzer during the fuzzing process. A fuzz test may further be provided, which represents the combined version of a fuzzer and a fuzz target. A fuzz test may be executable. The fuzzer may also start, observe, and stop multiple running fuzz tests (generally hundreds or thousands per second), each having a slightly different input generated by the fuzzer.

A test case may be a specific input and/or a test run of a fuzz test. In order to ensure repeatability, relevant test runs (which point out new code paths or crashes) may be stored. In this way, a specific test case with its corresponding input can also be executed on a fuzz target that is not connected to a fuzzer, e.g., in its release version.

According to an example embodiment of the present invention, the fuzzing may be implemented as a mutation-based fuzzing. New program inputs are generated by making small changes to existing inputs (also known as seeds) that, while still keeping the input valid, trigger a new behavior. A seed is an initial program input that can be used as a starting point for mutation-based fuzzing. The energy of a seed is the number of test cases that can be generated from a seed by mutations. The performance plan is the importance that a mutation-based fuzzer assigns to the seeds, which directly affects the sequence in which the seeds are queued for mutation.

According to an example embodiment of the present invention, to perform the software testing, a debugger may further be provided to control a target program and to provide functions for retrieving register or memory values, for example, and for stopping and interrupting the execution in individual steps. A breakpoint may be set via a debugger in response to an instruction of the target program to stop execution when said breakpoint is reached and to inform the controlling process thereof. A data watchpoint may be set via a debugger at a memory address of the target program to stop execution when said address is accessed and to inform the controlling process thereof.

Furthermore, it is optionally possible in the context of the present invention that the at least one item of secondary information is predicted by a model, preferably a machine learning model. In this respect, the model may result from training by means of training test cases and the effect thereof on a target program, as is described in particular for a training method according to the present invention. It is thus possible to take into account the effect of a specified test case in the generation of new test cases even without directly collecting the secondary information in the target program.

It is further possible that the at least one new test case may be generated by generating a mutation of the specified test case provided. The mutation can be used for the new test case, in particular if the predicted secondary information satisfies a specified condition, e.g. is indicative of a success of the specified test case. In this way, the secondary information may be used as a guiding criterion for the black box fuzzing.

Furthermore, according to an example embodiment of the present invention, it is optionally possible in the context of the present invention that the generation of the at least one new test case is optimized by an optimization method based on the predicted secondary information, that a specified condition is satisfied by the secondary information by influencing the effect on the target program by a mutation of the provided specified test case, wherein, via the effect, the specified condition specifies an attainment of extremes. In other words, the optimization method may perform the optimization of the new test case in such a way that the effect of the new test case on the target program is influenced such that the secondary information based thereon may meet the specified condition as far as possible.

According to an example embodiment of the present invention, it may further be possible for the following steps to be provided:
executing the generated new test case on the target program to execute the fuzzing and preferably black box fuzzing, wherein the at least one secondary information is predicted to enhance the fuzzing with knowledge about the effect on the target program, preferably to use the secondary information as a guiding criterion for the fuzzing,
ascertaining the at least one item of secondary information in the target program while executing the generated new test case thereon,
comparing the ascertained secondary information with a specified condition to determine whether the specified condition is satisfied,
incorporating the new test case into a seed corpus if the specified condition is satisfied, preferably to use the incorporated new test case as the specified test case for performing the method steps again.

In this way, the seed corpus may be expanded by relevant test cases.

Optionally, according to an example embodiment of the present invention, it is possible that the effect is an effect on a resource consumption and/or an execution time of the target program, preferably satisfying the specified condition if the at least one item of secondary information indicates an at least local extreme of the effect and/or an increase in resource consumption and/or an extension of execution time. Achieving such extremes may indicate the success of the test case and therefore serve as a guiding criterion.

The present invention also relates to a training method for a model, preferably a machine learning model, for predicting at least one secondary information for enhancing black box fuzzing, in particular to provide feedback, which is provided by the predicted secondary information. According to an example embodiment of the present invention, the following steps may be provided:
providing training data, wherein the training data specify training test cases and their effect on a target program to be tested,
training the model for predicting the at least one item of secondary information based on the provided training data, wherein the at least one item of secondary information indicates the effect,
providing the trained model.

Thus, the training method according to the present invention offers the same advantages as have been described in detail with reference to a method according to the present invention. Furthermore, the trained model resulting from the training method according to the present invention may also be a subject matter of the present invention.

The present invention also relates to a computer program, in particular a computer program product comprising instructions that, when the computer program is executed by a computer, cause said computer to perform the method according to the present invention. Therefore, the computer program according to the present invention offers the same advantages as have been described in detail with reference to a method according to the present invention.

The present invention also relates to a device for data processing configured to perform the method according to the present invention. The device may be a computer, for example, that executes the computer program according to the present invention. The computer may comprise at least one processor for executing the computer program. A non-volatile data memory may be provided as well, in which the computer program can be stored and from which the computer program can be read by the processor for execution.

The present invention may also relate to a computer-readable storage medium comprising the computer program according to the present invention and/or instructions that, when executed by a computer, cause said computer to carry out the method according to the present invention. The storage medium is implemented as a data memory, for example, such as a hard drive, and/or a non-volatile memory, and/or a memory card. The storage medium may be integrated in the computer, for example.

The method according to the present invention may moreover also be implemented as a computer-implemented method.

Further advantages, features, and details of the present invention emerge from the following description, in which exemplary embodiments of the present invention are described in detail with reference to the figures. In this context, the features disclosed herein can each be essential to the present invention individually or in any combination.

### BRIEF DESCRIPTION OF THE DRAWINGS

FIG. 1 shows a schematic visualization of a method, a training method, a model, a device, a storage medium, and a computer program according to exemplary embodiments of the present invention.

FIG. 2 further details of exemplary embodiments of the present invention.

### DETAILED DESCRIPTION OF EXAMPLE EMBODIMENTS

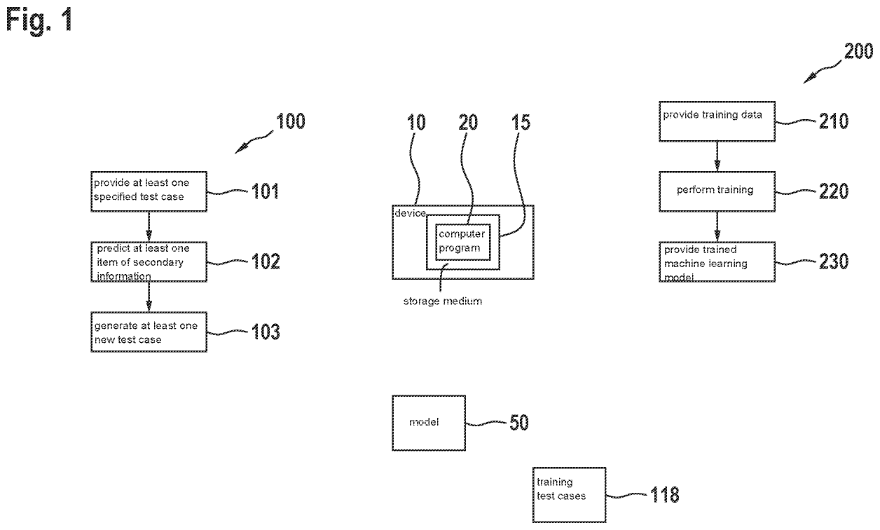

FIG. 1 schematically shows a method 100, a device 10, a storage medium 15, a model 50, a training method 200, and a computer program 20 according to exemplary embodiments of the present invention. The method 100 may serve for generating at least one new test case 115 based on black box fuzzing of a target program 140 to be tested. For this purpose, according to a first method step 101, at least one specified test case 110 for the black box fuzzing may be provided. For example, the test case 110 may have been manually specified or automatically and randomly generated.

However, it may be unknown what effect such an existing test case 110 has on target program 140. Thus, it is also not known to what extent a software test with said test case 110 is promising. Thus, according to a second method step 102, a prediction of at least one item of secondary information 120 may be performed based on the provided specified test case 110, wherein the at least one item of secondary information 120 is specific for the effect of the provided specified test case 110 on the target program 140 to be tested. This allows at least one new test case 115 to be generated based on the prediction 102 according to a third method step 103. By considering the effect, the new test case 115 may be generated as a promising and therefore more relevant test case 115 than would be possible without the prediction.

For example, a model 50, preferably a machine learning model 50, may be provided to enable prediction. The model 50 may result from training by means of training test cases 118 and their effect on a target program 140 by the training method 200. For this purpose, training data specifying the training test cases 118 and their effect on a target program 140 to be tested may be provided according to a first training step 210. The effects may be indicated by annotation data, for example, which are ascertained by an experimental observation of the effect when executing the training test cases on the target program. Subsequently, according to a second training step 220, training of the machine learning model 50 for predicting the at least one secondary item of information 120 may be performed based on the provided training data. According to a third training step 230, the provision of the trained machine learning model 50 may then be provided, e.g. by digitally and non-volatilely storing the optimized weightings of the trained machine learning model 50.

Black box fuzzing is a standard test method if no source code is present. However, the majority of fuzzing research is focused on improving fuzzing in the gray box configuration or white box configuration, as the black box configuration is the most difficult to improve. Machine learning has already been used to improve fuzzing. Neural byte sieve [5] experiments with several types of recurrent neural networks that learn to predict optimal locations in the input bytes for performing mutations. Angora [2] uses byte-level taint tracking and gradient descent to mutate test cases toward a new coverage. FuzzerGym [3] and Böttinger et al. [1] formulate fuzzing as a reinforced learning problem that optimizes coverage. Neural program smoothing [7], [6], [8] learns to specify code coverage of a program based on program inputs with the goal of using gradient descent to generate new test cases. However, none of these papers consider black box fuzzing.

Exemplary embodiments of the present invention may improve black box fuzzing by observing the secondary information 120 available when running target program 140 with test cases. The secondary information 120 may therefore be effectively used as a guiding criterion for fuzzing, thereby converting the setup of black box fuzzing into a new type of gray box fuzzing despite the lack of access to the source code and internals of the program.

The secondary information 120, which is typically available for observation when the software to be tested is running, may include, but is not limited to:
a program output,
an execution time,
a utilization of computing resources (e.g., memory usage, CPU usage).

The fuzzer 150 may take into account one or more of the above criteria, with the aim of finding the test cases that minimize or maximize each individual criterion. In particular, the present invention is based on the consideration that the fuzzer 150 can be encouraged to find test cases that reach extreme conditions. Such conditions indicate behavior that should reasonably be tested by fuzzing, as edge cases and extreme cases are typically more likely to find problems in the software. In so doing, the fuzzer may be enhanced with access to the proposed secondary information 120 that can be observed when the target program is running.

For the enhancement, a supervised learning process may be employed in which a machine learning model 50 learns to predict the observed secondary information 120 for a target program based on the program inputs. In particular, the supervised machine learning method and/or the machine learning model 50 may be suitable for processing program inputs. For example, the machine learning model 50 is implemented as a (at least one) neural network. Three phases may be provided for providing and applying the machine learning model 50, which are described below with further details.

According to a first phase, data collection may be optionally performed. For the training of the machine learning model 50, preliminary data collection may be provided in that the data are collected by executing the seed corpus on the target program while the fuzzer observes and collects the selected types of secondary conditions that are to be used as annotation data and/or labels. This step may be skipped if such a data set already exists. The collected data or data set may then be used as training data.

According to a second phase, the model training may occur. To do so, the machine learning model 50 may be trained in a supervised mode based on the training data. Training test cases may be used as model inputs while one or more types of secondary information are used as labels. The model 50 may be trained so as to predict multiple types of secondary information when using multi-task learning.

According to a third phase, fuzzing may be performed using the trained machine learning model. Once trained, the model 50 may be used in the fuzzing loop. For each test case 110 that the fuzzer 150 executes on the target program 140, the model 50 may predict the secondary information 120.

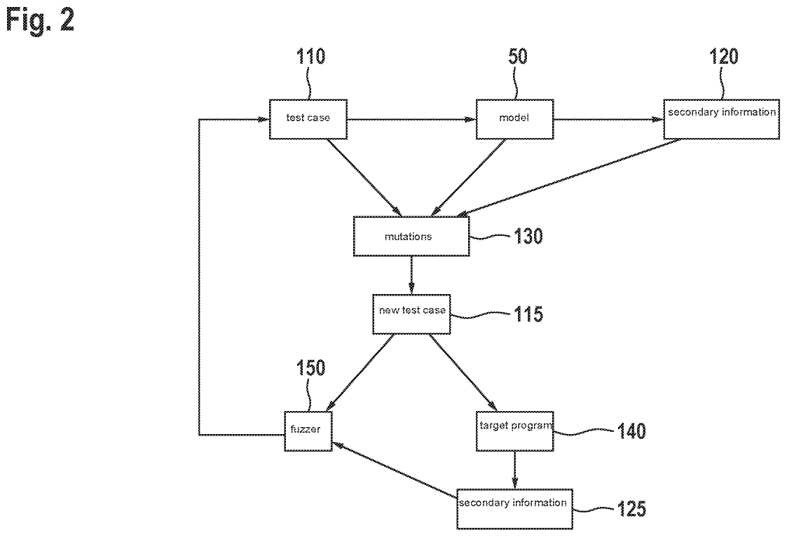

Numerical optimization methods (e.g., gradient ascent or descent) and back propagation may be applied to the trained model 50 to find the mutation of the test case 110 that alters the secondary information 120 in such a way that extreme points are reached (e.g., the shortest program output, the highest memory consumption, the longest execution time). The test cases 115 generated by said mutations 130 may be passed to the fuzzer, which executes them on the target program 140 and examines the same for secondary information 125. If said cases actually improve the optimized criteria, the fuzzer 150 can incorporate them into the seed corpus for further mutations. This workflow is illustrated in FIG. 2. The machine learning model 50 may be retrained from time to time as more test cases 110, 115 accumulate in the corpus. Alternatively, an online learning approach can be used in which the model 50 is continually improved as the corpus grows.

Exemplary embodiments of the present invention may be based on mutation-based fuzzing, wherein a seed corpus is used as a starting point for generating new test cases 115 and program inputs. The seed corpus may comprise a collection of already existing input data, typically collected manually or automatically. The process of generating new test cases 115 and program inputs may begin with the mutations being applied to the existing seed data to generate new data. For example, said mutations 130 may be random bit flips, byte changes, or other changes to the existing data. Each of said generated data may then be passed to the target program 140 to be tested as a new test case 115. If the target program to be tested does not react to such an input as expected or crashes, then this may be indicative of a vulnerability or error in the target program. In that case, the erroneous input may be incorporated into the corpus as a new seed to improve the quality of the test cases and perform further random mutations on that basis. In this way, by continuously generating new test cases 115 and using erroneous input data from the seed corpus, it can more effectively look for vulnerabilities and more fully test the target program to be tested. In order to further improve the generation of the new test cases 115, the method 100 according to exemplary embodiments may additionally take into account the predicted secondary information 120.

The above explanation of the example embodiments describes the present invention solely within the scope of examples. Of course, individual features of the embodiments may be freely combined with one another, if technically expedient, without leaving the scope of the present invention.

### REFERENCES

[1] Konstantin Böttinger, Patrice Godefroid, and Rishabh Singh. Deep reinforcement fuzzing. In IEEE Security and Privacy Workshops (SPW), pages 116-122, 2018.
[2] Peng Chen and Hao Chen. Angora: Efficient fuzzing by principled search. In IEEE Symposium on Security and Privacy (SP), 2018.
[3] William Drozd and Michael D. Wagner. Fuzzergym: A competitive framework for fuzzing and learning. CoRR, 2018.
[4] Valentin Jean Marie Man 'es, HyungSeok Han, Choongwoo Han, Sang Kil Cha, Manuel Egele, Edward J Schwartz, and Maverick Woo. The art, science, and engineering of fuzzing: A survey. IEEE Transactions on Software Engineering, 2019.
[5] Mohit Rajpal, William Blum, and Rishabh Singh. Not all bytes are equal: Neural byte sieve for fuzzing. CoRR, 2017.
[6] Dongdong She, Rahul Krishna, Lu Yan, Suman Jana, and Baishakhi Ray. MTFuzz: fuzzing with a multi-task neural network. In ACM Joint European Software Engineering Conference and Symposiumon the Foundations of Software Engineering (ESEC/FSE), 2020.
[7] Dongdong She, Kexin Pei, Dave Epstein, Junfeng Yang, Baishakhi Ray, and Suman Jana. Neuzz: efficient fuzzing with neural program smoothing. In IEEE Symposium on Security and Privacy (S&P), 2019.
[8] Mingyuan Wu, Ling Jiang, Jiahong Xiang, Yuqun Zhang, Guowei Yang, Huixin Ma, Sen Nie, Shi Wu, Heming Cui, and Lingming Zhang. Evaluating and improving neural program-smoothing-based fuzzing. In International Conference on Software Engineering (ICSE), 2022.

What is claimed is:

1. A method for generating at least one new test case based on black box fuzzing of a target program to be tested, the method comprising the following steps:
providing at least one specified test case;
predicting at least one item of secondary information based on the provided specified test case, wherein the at least one item of secondary information is specific for an effect of the provided specified test case on the target program to be tested; and
generating the at least one new test case based on the prediction.

2. The method according to claim 1, wherein the at least one item of secondary information is predicted by a model.

3. The method according to claim 1, wherein the at least one item of secondary information is predicted by a machine learning model, wherein the machine learning model results from training via training test cases and an effect of the training test cases on a target program.

4. The method according to claim 1, wherein the at least one new test case is generated by generating a mutation of the provided specified test case, wherein the mutation is used for the new test case when the predicted at least one item of secondary information satisfies a specified condition, to use the at least one item of secondary information as a guiding criterion for the black box fuzzing.

5. The method according to claim 1, wherein the generation of the at least one new test case is optimized by an optimization method based on the predicted at least one item secondary information in that a specified condition is satisfied by the at least one item of secondary information by influencing the effect on the target program by a mutation of the provided specified test case, wherein, via the effect, the specified condition specifies an attainment of extremes.

6. The method according to claim 1, wherein the following steps are provided:
executing the generated new test case on the target program to perform the black box fuzzing, wherein the at least one item of secondary information is predicted to enhance the black box fuzzing with knowledge about the effect on the target program, including to use the at least one item of secondary information as a guiding criterion for fuzzing;
ascertaining the at least one item of secondary information at the target program while the generated new test case is executed on the target program;
comparing the ascertained at least one secondary information with a specified condition to determine whether the specified condition is satisfied; and
incorporating the new test case into a seed corpus when the specified condition is satisfied, in order to use the incorporated new test case as the specified test case for performing the method steps again.

7. The method according to claim 1, wherein the effect is an effect on a resource consumption of the target program and/or an execution time of the target program.

8. The method according to claim 4, wherein the effect is an effect on a resource consumption of the target program and/or an execution time of the target program, and wherein the specified condition is satisfied when the at least one item of secondary information indicates an at least local extreme of the effect and/or an increase in resource consumption and/or an extension of the execution time.

9. A training method for a model for predicting at least one item of secondary information for an enhancement of black box fuzzing, comprising the following steps:
providing training data, wherein the training data specify training test cases and an effect of the training test cases on a target program to be tested;
training the model for predicting the at least one item of secondary information based on the provided training data, wherein the at least one item of secondary information indicates an effect; and
providing the trained model.

10. A device for data processing configured to generate at least one new test case based on black box fuzzing of a target program to be tested, the device configured to:
provide at least one specified test case;
predict at least one item of secondary information based on the provided specified test case, wherein the at least one item of secondary information is specific for an effect of the provided specified test case on the target program to be tested; and
generate the at least one new test case based on the prediction.

11. A non-transitory computer-readable storage medium on which are stored instructions generating at least one new test case based on black box fuzzing of a target program to be tested, the instructions, when executed by a computer, causing the computer to perform the following steps:
providing at least one specified test case;
predicting at least one item of secondary information based on the provided specified test case, wherein the at least one item of secondary information is specific for an effect of the provided specified test case on the target program to be tested; and
generating the at least one new test case based on the prediction.
